(19) United States
(12) Patent Application Publication
(10) Pub. No.: US 2013/0212844 A1
(43) Pub. Date: Aug. 22, 2013

(54) ADJUSTABLE CLAMPING DEVICE

(71) Applicant: Jun Fan CHEN, Taichung City 408 (TW)

(72) Inventor: Jun Fan CHEN, Taichung City 408 (TW)

(21) Appl. No.: 13/589,150

(22) Filed: Aug. 19, 2012

(30) Foreign Application Priority Data
Feb. 21, 2012 (TW) 101203095

(51) Int. Cl. F16B 2/02

(52) U.S. Cl. 24/505

(57) ABSTRACT

An adjustable clamping device is provided. The device includes a first and a second clamping body, an adjusting mechanism and an elastic member. The first clamping body includes a first jaw formed with a first locking member and a first connecting portion formed with first limiting portion. The second clamping body includes a second jaw formed with second blocking member and a second connecting portion formed with at least two second limiting portions. A jaw opening is formed between the first and second jaws. The adjusting mechanism includes a shaft which is rotatably positioned at the first limiting portion and selectively positioned at one of the second limiting portions.

### BACKGROUND OF THE INVENTION

1. Field of the Invention

The present invention relates to an adjustable clamping device.

2. Description of the Prior Art

A multiport valve is used mainly to connect a primary pipe and manifold pipes, so as to decrease the amount of the pipes mounted between two devices.

When some of the openings of the multiport valve should be somehow temporarily closed, a conventional plug is usually used to close the openings to be closed, and other openings of the multiport valve are still connected to the pipes and can allow the gas or liquid in the primary pipe to flow into the device to which the pipes are connected. However, the gas or liquid could generate pressure, and the plug resists the gas or liquid pressure by means of the friction between the plug and the pipe of the multiport valve. The resistance of the plug to the gas or liquid pressure is usually insufficient, and thus the plug will be pushed outwardly by degrees such that the gas or liquid can leak.

Furthermore, a conventional clamping device is used to close two openings of a multiport valve via its two jaws, and the clamping outcome is better than that of the conventional plug due to the clamping device can perform with a greater clamping force. However, the two jaws of the conventional clamping device are formed with respective flat clamping surfaces, thus resulting in a worse clamping performance so that the clamping device can easily disengage from the multiport valve and the gas or liquid leaks.

Additionally, the breadth of the jaw opening between the two jaws of the conventional clamping device is much limited and cannot be applied to various kinds of multiport valves and various kinds of hoses whose diameters are different.

The present invention is, therefore, arisen to obviate or at least mitigate the above mentioned disadvantages.

### SUMMARY OF THE INVENTION

One object of the present invention is to provide an adjustable clamping device, in which a breadth of a jaw opening thereof is adjustable.

Another object of the present invention is to provide an adjustable clamping device which is used to close two openings of a multiport valve.

To achieve the above and other objects, an adjustable clamping device of the present invention includes a first clamping body, a second clamping body, an adjusting mechanism and an elastic member.

The first clamping body includes a first jaw and a first handle.

The second clamping body includes a second jaw and a second handle, and a jaw opening is defined between the first jaw and the second jaw.

The first clamping body includes a first connecting portion, the first connecting portion extends from an interconnection of the first jaw and the first handle toward the second clamping body, the second clamping body includes a second connecting portion, and the second connecting portion extends from an interconnection of the second jaw and the second handle toward the first clamping body.

The first connecting portion is formed with at least one first limiting portion, the second connecting portion is formed with at least two second limiting portion, and the two second limiting portions are separately arranged in a direction in which the second connecting portion extends.

The adjusting mechanism includes a shaft, the shaft is rotatably positioned at the first limiting portion and selectively positioned at one of the second limiting portion, the second clamping body is movable between a first position and a second position with respect to the first clamping body, and when the second clamping body is located at the first position, the jaw opening is diminished in breadth.

The first and second clamping bodies pivot around the shaft between an open position and a close position, respectively.

The elastic member is disposed between the first and second clamping bodies, and the elastic member provides a spring force so that the first and second jaws tend to move toward the close position.

Since the jaw opening of the adjustable clamping device is adjustable in breadth, it is suitable for various kinds of multiport valves, the first and second blocking members can provide excellent closing effects, and the disengagement of the clamping device from the multiport valve can be avoided.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown drawing of a preferred embodiment of the present invention;

FIG. 3 is a drawing showing an adjusting member at an unlocked position according to a preferred embodiment of the present invention;

FIG. 4 is a drawing showing the adjusting member at a locked position according to a preferred embodiment of the present invention;

FIG. 5 is a drawing showing a multiport valve having two openings being clamped according to a preferred embodiment of the present invention;

FIG. 6 is a drawing showing a second clamping body at a first position according to a preferred embodiment of the present invention; and

FIG. 7 is a drawing showing another multiport valve having two openings being clamped according to a preferred embodiment of the present invention.

### DETAILED DESCRIPTION OF THE PREFERRED EMBODIMENTS

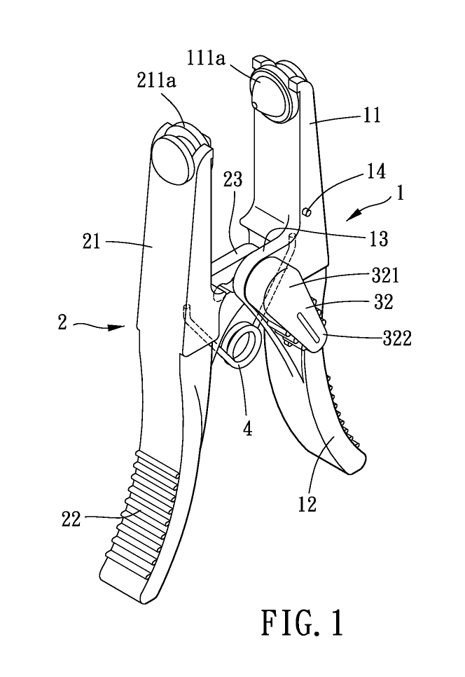

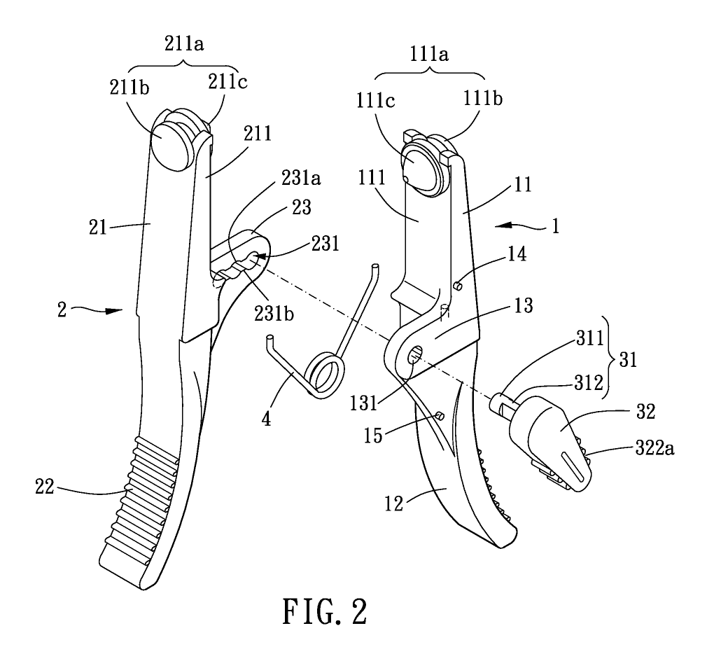

As shown in FIGS. 1 and 2, an adjustable clamping device of the present invention includes a first clamping body 1, a second clamping body 2, an adjusting mechanism and an elastic member 4.

The first clamping body 1 includes a first jaw 11, a first handle 12, a first connecting portion 13, an unlocking portion 14 and a locking portion 15.

The first jaw 11 extends from one end of the first handle 12 in a longitudinal direction of the first handle 12 so that the first clamping body 1 is elongated. In addition, the first jaw 11 has a first clamping surface 111 formed with a slot and a first blocking member 111a. The first blocking member 111a includes a positioning portion 111b and a plug 111c, and the plug 111 extends from the top of the positioning portion 111b and is cone-shaped. The positioning portion 111b is detachably disposed in the slot, and the plug 111c faces toward the second clamping body 2.

The first connecting portion 13 extends from an interconnection of the first jaw 11 and the first handle 12 toward the second clamping body 2, and extends by one side thereof near the first clamping body 1 in a direction parallel to the width direction of the first clamping body 1. Preferably, in a first direction perpendicular to the direction in which the first connecting portion 13 extends, the thickness of the first connecting portion 13 is smaller than that of the first clamping body 1, and the first connecting portion 13 is sheet-shaped. Additionally, the first connecting portion 13 is formed with at least one first limiting portion 131, and the first limiting portion 131 is preferably a through hole.

Either of the unlocking portion 14 and the locking portion 15 is a stuck member. The unlocking portion 14 is disposed at the first jaw 11, and the unlocking portion 14 and the first connecting portion 13 are located by the same side. The locking portion 15 is disposed at the first handle 12, and the locking portion 15 and the first connecting portion 13 are located by the same side.

The second clamping body 2 includes a second jaw 21, a second handle 22 and a second connecting portion 23.

The second jaw 21 extends from one end of the second handle 22 in a longitudinal direction of the second handle 22 so that the second clamping body 2 is elongated. Besides, the second jaw 21 has a second clamping surface 211 formed with a slot and a second blocking member 211a. The second blocking member 211a includes a positioning portion 211b and a plug 211c. The plug 211c extends from the top of the positioning portion 211b and is cone-shaped. The positioning portion 211b detachably disposed in the slot, and the plug 211c faces toward the first clamping body 1.

The second connecting portion 23 extends from an interconnection of the second jaw 21 and the second handle 22 toward the first clamping body 1, and extends by one side thereof near the second clamping body 2 in a direction parallel to the width direction of the second clamping body 2. Preferably, in the first direction, the thickness of the second connecting portion 23 is smaller than that of the second clamping body 2, and the second connecting portion 23 is sheet-shaped. The second connecting portion 23 is formed with at least two second limiting portion 231. In this embodiment, the second connecting portion 23 is formed with three second limiting portion 231, and the second limiting portions 231 are separately arranged in a direction in which the second connecting portion 23 extend. Preferably, each of the second limiting portions 231 is a through hole and communicated with the adjacent through hole. Each of the through holes includes an enlarged section 231a, and a necked section 231b is formed between each two adjacent through holes.

When the first clamping body 1 and the second clamping body 2 are assembled, the first and second connecting portions 13, 23 are stacked and a jaw opening is formed between the first jaw 11 and the second jaw 21.

The adjusting mechanism includes a shaft 31 and an adjusting member 32. The shaft 31 is rotatably positioned at the first limiting portion 131 and selectively positioned at one of the second limiting portions 231. More specifically, the shaft 31 includes a head portion 311 and a neck portion 312, the adjusting member 32 includes a head portion 321 and a handle portion 322, the head portion 311 of the shaft is formed at one end of the neck portion 312 of the shaft, the other end of the neck portion 312 is connected to the head portion 321 of the adjusting member. The adjusting member 32 is rotatable between an unlocked position and a locked position and can drive the shaft 31 to rotate, such that the shaft 31 can selectively run through the necked section 231b and be positioned at one of the second limiting portions. Hence, the second clamping body 2 is movable between a first position and a second position with respect to the first clamping body 1, and the first and second clamping bodies 1, 2 can pivot around the shaft 31 between an open position and a close position, respectively.

In this embodiment, the head portion 311 of the shaft is larger than the through hole in size, a longitudinal extent of the neck portion 312 is larger than that of each through hole. A greatest extent of the neck portion 312 in a width direction is larger than that of the necked section 231b, and a greatest extent of the neck portion 312 in a thickness direction is smaller than that of the necked section 231b. The width direction of the neck portion 312 is perpendicular to the thickness direction of the neck portion 312, such that the shaft 31 can selectively run through the necked section 231b. The handle portion 322 of the adjusting member includes a first side surface and a second side surface in a width direction of the handle portion, the first side surface is formed with two projections, and a slot 322a is formed between the two projections.

The elastic member 4 is disposed between the first and second clamping bodies 1, 2. Preferably, the elastic member 4 is a torsion spring and can provide a spring force so that the first and second jaws 11, 21 tend to move toward the close position.

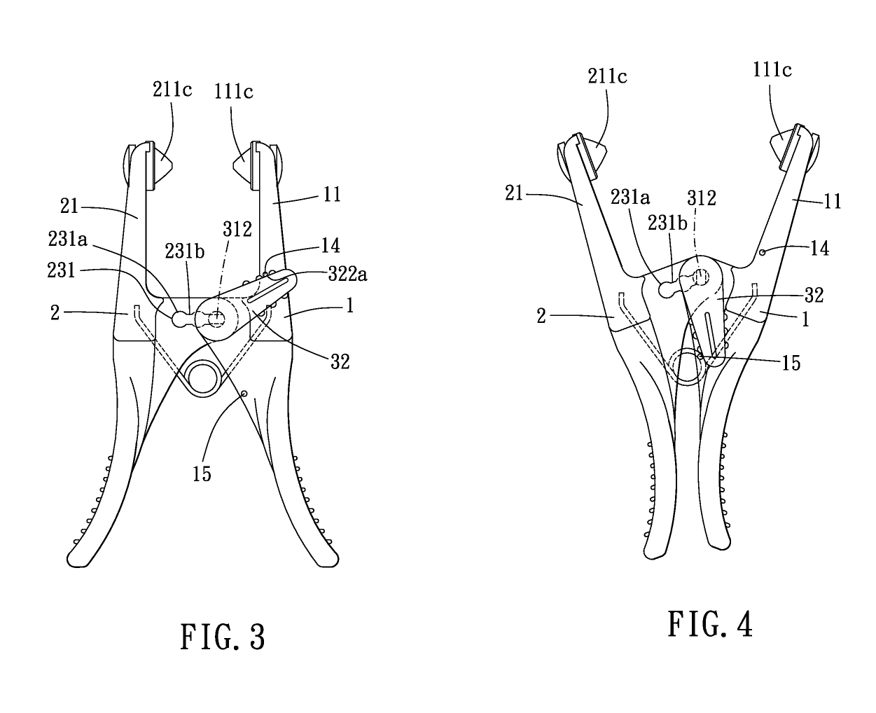

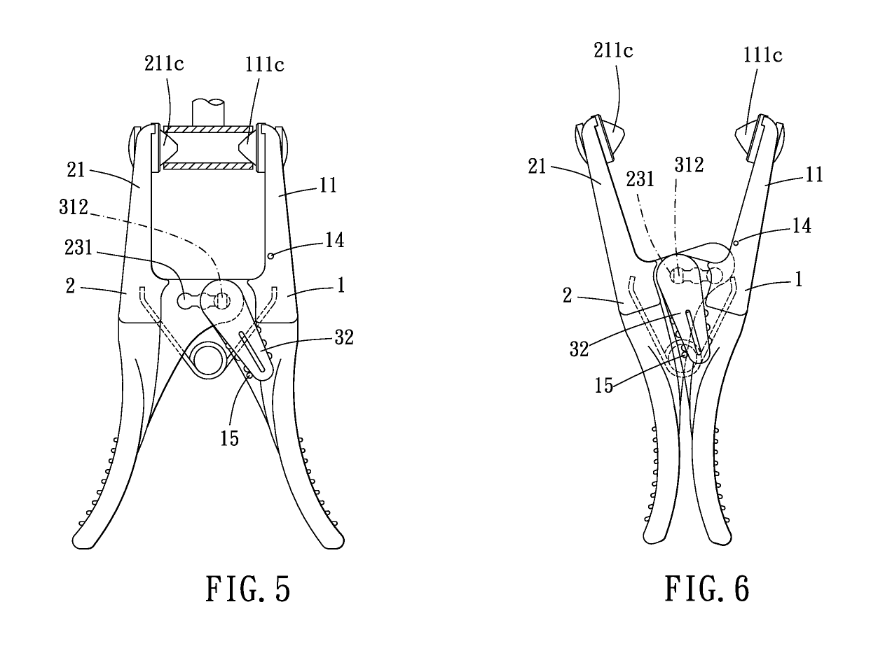

When an user uses the adjustable clamping device to clamp a multiport valve having two openings (the two openings correspond to each other), the breadth of the jaw opening can be adjusted according to the distance between the two openings of the multiport valve. As shown in FIG. 1 and FIGS. 3 to 5, when an user uses the adjustable clamping device to clamp a multiport valve having two openings with a relatively larger distance between the two openings of the multiport valve, the breadth of the jaw opening has to be adjusted to be relatively largest so as to clamp and close the two openings. The adjusting member 32 is rotated to at the unlocked position such that the handle portion 322 of the adjusting member is positioned at the unlocking portion 14 (the stuck member is received in the slot 322a), in the meanwhile, the width direction of the neck portion 312 of the shaft is parallel to a direction in which the second connecting portion 23 extends. The shaft 31 can run through the necked sections 2311b and slide between the second limiting portions 231, and it needs only to slide the shaft to the rightmost second limiting portion 231 (i.e., the second clamping body 2 moves to the second position), and thus the breadth of the jaw opening is relatively largest. The adjusting member 32 is then rotated to at the locked position so that the handle portion 322 of the adjusting member is positioned at the locking portion 15, in the meanwhile, the thickness direction of the neck portion 312 of the shaft is parallel to the direction in which the second connecting portion 23 extends, and the shaft 31 unallow to run through any of the necked sections 231b so as to be fixedly positioned at the second limiting portion 231. Finally, the first and second jaws 11, 21 is pivoted to the open position, and the plug 111c, 211c of the first and second blocking members correspond respectively to the two openings and the two openings are closed therewith, whereby completely closing the two openings of the multiport valve.

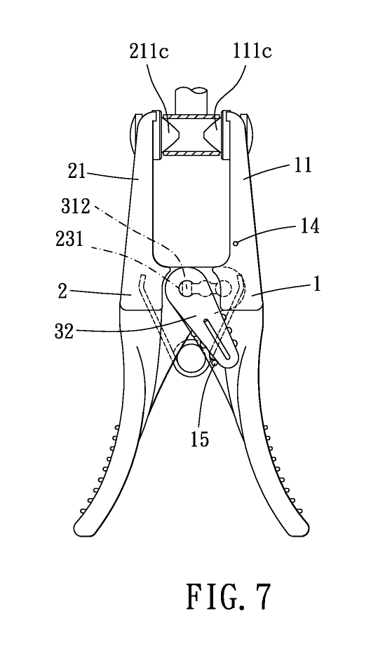

As shown in FIG. 6 and FIG. 7, when a user uses the adjustable clamping device to clamp a multiport valve having two openings with a relatively smaller distance between the two openings of the multiport valve, the breadth of the jaw opening has to be adjusted to be relatively smallest so as to clamp and close the two openings. Like the above-mentioned operation procedure, it needs only to slide the shaft 31 to the leftmost second limiting portion 231 (i.e., the second clamping body 2 moves to the first position), and thus the breadth of the jaw opening is relatively smallest and the two openings are completely closed via proceeding an operation procedure like the above-mentioned one.

In sum, since the breadth of the jaw opening of the adjustable clamping device of the present invention is adjustable, it can be suitable for clamping various kinds of multiport valves. When the cone-shaped plug 111c, 211c of the first and second blocking members plug the two openings, with the spring force provided by the elastic member 4, the first and second blocking members 111a, 211a can sufficiently resist the gas or liquid pressure when the gas or liquid flow through the multiport valve, such that the first and second blocking members 111a, 211a can perform with excellent effect of closing, and the gas or liquid cannot leak from the multiport valve. In addition, the disengagement of the first and second blocking members 111a, 211a from the multiport valve can be avoided.

Furthermore, the unlocking portion 14 and the locking portion 15 can not only help the user to recognize the current use state of the adjustable clamping device but also hold the handle portion 322 of the adjusting member, such that the adjusting member 32 cannot pivot freely and does not affect the clamping effect.

The adjustable clamping device of the present invention is not limited to be applied to multiport valves and may be applied to various hoses whose diameters are different, for example. The first and second blocking members 111a, 211a may be used to clamp the hose and to close openings of the interior passageway of the hose, whereby the gas or liquid cannot leak from the hose.

Additionally, since the first and second blocking members 111a, 211a are detachable, the first and second blocking members 111a, 211a can be detached and then used to clamp other object.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An adjustable clamping device, including:
a first clamping body, including a first jaw and a first handle;
a second clamping body, including a second jaw and a second handle, and a jaw opening being defined between the first jaw and the second jaw;
wherein the first clamping body includes a first connecting portion, the first connecting portion extends from an interconnection of the first jaw and the first handle toward the second clamping body, the second clamping body includes a second connecting portion, and the second connecting portion extends from an interconnection of the second jaw and the second handle toward the first clamping body;
wherein the first connecting portion is formed with at least one first limiting portion, the second connecting portion is formed with at least two second limiting portion, and the two second limiting portions are separately arranged in a direction in which the second connecting portion extends;
an adjusting mechanism, including a shaft, the shaft rotatably positioned at the first limiting portion and selectively positioned at one of the second limiting portion, the second clamping body is movable between a first position and a second position with respect to the first clamping body, and when the second clamping body is located at the first position, the jaw opening is diminished in breadth;
wherein the first and second clamping bodies pivot around the shaft between an open position and a close position, respectively; and
an elastic member, disposed between the first and second clamping bodies, and the elastic member provides a spring force so that the first and second jaws tend to move toward the close position.

2. The adjustable clamping device of claim 1, wherein the second limiting portions are through holes, each of the through holes is communicated with the adjacent through hole, each through hole is formed with an enlarged section, a necked section is formed between each two adjacent through holes, and the shaft selectively runs through the necked section.

3. The adjustable clamping device of claim 2, wherein the adjusting mechanism includes an adjusting member, one end of the shaft is connected to the adjusting member, the adjusting member is rotatable between an unlocked position and a locked position, the shaft runs through the necked sections and slides between the second limiting portions when the adjusting member is located at the unlocked position, and the shaft unallow to run through the necked section and is fixed in one of the through holes when the adjusting member is located at the locked position.

4. The adjustable clamping device of claim 3, wherein the shaft includes a head portion and a neck portion, the head portion is larger than the through hole in size, a longitudinal extent of the neck portion is larger than that of each through hole, a greatest extent of the neck portion in a width direction is larger than that of the necked section, and a greatest extent of the neck portion in a thickness direction is smaller than that of the necked section.

5. The adjustable clamping device of claim 3, wherein the first clamping body is formed with an unlocking portion and a locking portion, the adjusting member includes a head portion and a handle portion, one end of the shaft is connected to the head portion, the handle portion is positioned at the unlocking portion when the adjusting member is rotated to locate at the unlocked position, and the handle portion is positioned at the locking portion when the adjusting member is rotated to locate at the locked position.

6. The adjustable clamping device of claim 5, wherein the unlocking portion is a stuck member.

7. The adjustable clamping device of claim 6, wherein the handle portion of the adjusting member includes a first side surface and a second side surface in a width direction thereof, the first side surface is formed with two projections, a slot is formed between the two projections, and the stuck member is received in the slot.

8. The adjustable clamping device of claim 5, wherein the locking portion is a stuck member.

9. The adjustable clamping device of claim 1, wherein the first jaw is formed with a first clamping surface, and the first clamping surface is formed with a first blocking member.

10. The adjustable clamping device of claim 9, wherein the second jaw is formed with a second clamping surface, the second clamping surface is formed with a second blocking member.

11. The adjustable clamping device of claim 10, wherein either of the first and second blocking members includes a plug, and the plugs are cone-shaped.

12. The adjustable clamping device of claim 10, wherein the first and second blocking members is detachable.

13. The adjustable clamping device of claim 2, wherein the first jaw is formed with a first clamping surface, and the first clamping surface is formed with a first blocking member.

14. The adjustable clamping device of claim 3, wherein the first jaw is formed with a first clamping surface, and the first clamping surface is formed with a first blocking member.

15. The adjustable clamping device of claim 4, wherein the first jaw is formed with a first clamping surface, and the first clamping surface is formed with a first blocking member.

16. The adjustable clamping device of claim 5, wherein the first jaw is formed with a first clamping surface, and the first clamping surface is formed with a first blocking member.

17. The adjustable clamping device of claim 6, wherein the first jaw is formed with a first clamping surface, and the first clamping surface is formed with a first blocking member.

18. The adjustable clamping device of claim 7, wherein the first jaw is formed with a first clamping surface, and the first clamping surface is formed with a first blocking member.

19. The adjustable clamping device of claim 8, wherein the first jaw is formed with a first clamping surface, and the first clamping surface is formed with a first blocking member.
